(19) United States
(12) Patent Application Publication
(10) Pub. No.: US 2025/0361995 A1
(43) Pub. Date: Nov. 27, 2025

(54) LIGHTING FLAME SIMULATOR WITH PROGRAMMABLE LIGHT SOURCE, ELECTRICAL FIREPLACE AND ASSEMBLING METHOD THEREOF

(71) Applicant: Source Pro Industries Ltd., Kowloon Bay (HK)

(72) Inventors: Jackey Chu, Kowloon Bay (HK); Charles Lam, Kowloon Bay (HK)

(73) Assignee: Source Pro Industries Ltd., Kowloon Bay (HK)

(21) Appl. No.: 18/671,294

(22) Filed: May 22, 2024

(51) Int. Cl. F21S 10/04; F21S 4/28; F21V 1/04; F21V 1/12; F21V 11/16; F21W 121/00; F21Y 113/17; F21Y 115/10; F24C 7/00; F24D 13/00

(52) U.S. Cl. CPC F21S 10/043; F21S 4/28; F21V 1/04; F21V 1/12; F21V 11/16; F24C 7/004; F24D 13/00; F21W 2121/00; F21Y 2113/17; F21Y 2115/10

(57) ABSTRACT

The present disclosure relates to a lighting flame simulator with a programmable light source, an electrical fireplace and assembling method thereof. The lighting flame simulator comprises a light source, a pattern screen and a projection screen, wherein the light source is a programmable light source, the pattern screen is provided with a translucent image which is visible when the light source is working, the projection screen is provided with translucent and transparent areas or is a translucent screen.

### TECHNICAL FIELD

The present disclosure generally relates to a lighting flame simulator with a programmable light source, an electrical fireplace and assembling method thereof.

### BACKGROUND

Most currently available electric fireplaces consist of a flame generator assembly comprising of a light source which is distorted into the shape of flames using a rotary electric reflector. The disadvantage of such rotary electric reflectors is the use of synchronous or step motor component which tend to create noise and represent a significant amount of cost. Another disadvantage is that the rotary spindle can easily come off its axis therefore creating more noise or fail to turn completely. This can cause a very poor user experience.

Additionally, such a flame generator assembly is relatively bulky take up a large amount of space and depth in the fireplace housing surface area which will negatively affect the visible depth and ornamental aesthetics of the faux fireplace components.

### SUMMARY

An objective of the present disclosure is to provide a lighting flame simulator with a programmable light source, which could form a lighting effect on the screen by controlling the brightness and color changes of the light source though a controller, without any need of a driving motor. Under such circumstance, the noise caused by the rotating of the driving motor is eliminated and the cost for the motor could be saved.

The present disclosure relates to a lighting flame simulator, comprising a light source, a pattern screen and a projection screen, wherein the light source is a programmable light source, the pattern screen is provided with a translucent image which is visible when the light source is working, the projection screen is provided with translucent and transparent areas or is a translucent screen.

In some embodiments, the programmable light source is a light strip, which is controlled through a programmable controller, or the programmable light source comprises dispersedly arranged multiple lamps, which are controlled by a programmable controller, or the programmable light source includes a PCB upon which is provided with one or more LED light bulbs, or the programmable light source is arranged under the pattern screen. In some embodiments, the programmable light source is arranged on a reflective surface or a reflective membrane to form a lighting member, or the programmable light source is arranged in an enclosure to form a lighting member.

Further, in front of the projection screen is provided with a decorative module, the projection screen has a transparent area or opening to allow light to go into the decorative module. In some embodiments, the lighting member and the pattern screen are combined, and the projection screen is separated; or the projection screen and the pattern screen are combined, and the lighting member is separated; or the lighting member, the pattern screen and the projection screen are combined to form an integral assembly. In some embodiments, further comprises at least one of a heating module and a decorative module, wherein at least one of the heating module and the decorative module are enclosed in a packing member to form an integral assembly with the light source, the pattern screen and the projection screen.

Another objective of the present disclosure is to provide an electric fireplace, comprising the lighting flame simulator with a programmable light source as described above and a cabinet. In some embodiments, the cabinet is provided in a form of a modular cabinet assembly that is configured to be assembled, along with the lighting flame simulator.

Under such circumstance, since there is no need to provide any mounting space for the rotary flame generator, the space of the cabinet could be reduced, a more compacted product could be possible and/or allow more space for ornamental components to enhance the realistic aspect of the product.

Yet another objective of the present disclosure is to provide combination that is configured for receipt by a consumer, the combination comprising the electric fireplace as described above in an assembled configuration and a package assembly; wherein the electric fireplace is positionable within the package assembly when in an unassembled configuration; and wherein the package assembly with the electric fireplace in the unassembled configuration positioned therein is selectively receivable by the consumer.

Yet another objective of the present disclosure is to provide a method for assembling an electric fireplace, comprising the steps of:
providing a cabinet assembly in an unassembled configuration, the cabinet assembly including a plurality of unassembled, cabinet structural components;
assembling a part of the cabinet structural components to form a base portion and mounting two pieces of vertically mounted plates on the base portion;
positioning a lighting flame generator to engage with the vertically mounted plates; the lighting flame generator comprising a programmable light source, a pattern screen and a projection screen, the pattern screen providing with a translucent image which is visible when the light source is working, the projection screen providing with translucent and transparent areas or the projection screen being a translucent screen;
assembling a cover plate above the lighting flame generator; assembling a heating module onto the cover plate;
assembling other cabinet structural components to form an electric fireplace.

### BRIEF DESCRIPTION OF THE DRAWINGS

These and other features, aspects, and advantages of the present invention will become better understood with reference to the following description, appended claims, and accompanying drawings, in which similar reference characters refer to similar parts, and in which:

FIG. 1 shows a front view of an electric fireplace according to the present disclosure;

FIG. 2 shows a rear view of an electric fireplace according to the present disclosure;

FIG. 3 shows a rear view of a lighting flame simulator according to the present disclosure;

FIG. 4 shows a front view of the lighting flame simulator as shown in FIG. 3;

FIG. 5 shows an exploded view of the lighting flame simulator as shown in FIG. 3;

FIG. 6 shows an exploded view of another lighting flame simulator according to the present disclosure;

FIG. 7 shows a first embodiment of the lighting flame simulator according to the present disclosure;

FIG. 8 shows a second embodiment of the lighting flame simulator according to the present disclosure;

FIG. 9 shows a front view of a third embodiment of the lighting flame simulator according to the present disclosure;

FIG. 10 shows a rear view of the lighting flame simulator as shown in FIG. 9;

FIG. 11 shows a front view of an assembled electric fireplace according to the present disclosure;

FIGS. 12-13 show a first embodiment of assembling a lighting flame simulator according to the present disclosure;

FIG. 14 shows a second embodiment of assembling a lighting flame simulator according to the present disclosure;

FIG. 15 shows a third embodiment of assembling a lighting flame simulator according to the present disclosure;

FIG. 16 shows a further step of assembling a lighting flame simulator, in which a front cover is inserted;

FIG. 17 shows a further step of assembling a lighting flame simulator, in which a cover plate is inserted;

FIG. 18 shows a schematic view of a heating module according to the present disclosure;

FIG. 19 shows a schematic view of assembling a heating module as shown in FIG. 18;

FIG. 20 shows an exploded view of an electric fireplace according to the present disclosure;

FIG. 21 shows an assembled electric fireplace according to the present disclosure;

FIG. 22 shows yet another embodiment of a lighting flame simulator according to the present disclosure;

FIG. 23 shows an exploded view of the lighting flame simulator as shown in FIG. 22;

FIG. 24 shows yet another embodiment of a lighting flame simulator according to the present disclosure;

FIG. 25 shows an exploded view of the lighting flame simulator as shown in FIG. 24;

FIGS. 26-27 show other two embodiments of a lighting flame simulator with a frame according to the present disclosure.

FIG. 28 shows another embodiment of a lighting flame simulator different to embodiments in FIGS. 26-27.

FIG. 29 shows the positioning of the light strip in FIG. 28.

FIG. 30 shows the illuminating effect of the embodiment in FIG. 28.

### DETAILED DESCRIPTION

In order to make the objectives, technical solutions and advantages of the present disclosure clearer, the embodiments of the present disclosure will be described below in detail with reference to the accompanying drawings. The technical features in different embodiments of the present disclosure may be combined with each other if not conflicted.

Embodiments of the present invention are described herein in the context of a layered and programmable lighting flame simulator and an electric fireplace with such a layered and programmable lighting flame simulator. More particularly, it enables greater flexibility to the consumer for the overall design of the electric fireplace, as well as offering various cost and product development efficiencies. For example, numerous options for different components of the electric fireplace can be incorporated together in any desired manner to provide various alternatives for the consumer in terms of the overall size, shape, design and aesthetic appearance of the electric fireplace.

As shown in FIG. 6, a lighting flame simulator of the present disclosure comprises a lighting member 50, a pattern screen 21 and a projection screen 20 that are preferably sequentially arranged. The front surface 51 of the lighting member 50 may be a reflective surface or a reflective membrane. A light source 52 is arranged on the front surface 51, and the light source 52 may be at least one light strip as shown. The light emitted by the light source produces a glow effect on the front surface 51. The light source also would typically be mounted onto a circuit board and could be nested or fixed to a plastic holder with an embedded receptacle for a power source.

The light source 52 can also have other suitable designs. For example, in a non-exclusive alternative embodiment, the light source 52 can include a PCB upon which is provided with one or more LED light bulbs. It is appreciated that the use of LED light bulbs makes it unnecessary to access the light source 52 as the LED light bulbs have a very long life span and do not need to be regularly replaced. Additionally, the light source 52 can be positioned in any suitable manner for purposes of more effectively simulation effect.

In one embodiment, the lighting member 50 may have a plastic enclosure, inside of which is provided with the light source 52, which can be programmed to make light move up and down in different natural speeds and sequences, and produce a dynamic flame simulation effect. The pattern screen 21 can be a membrane with a translucent flame/smoke image which provides a general shape and a light filtering layer to the light emitted by the light source 52, to create a flame shape and different color variations, shade variations and light intensity variations by filtering the light source. The flame/smoke image on the pattern screen 21 is visible when the lighting flame generator is in use. Multiple filtering membranes could be used to offer more depth and aspects to the projected image. Alternatively, pattern screen 21 may also have transparent or cut-out openings to let light through in certain areas as well as opaque areas to block the light.

Projection screen 20 can be a translucent screen to project the image created by the pattern screen 21. Projection screen 20 can have cladding design of bricks or other printing, or could remain a uniform color and/or tint. Projection screen 20 may have a transparent area or opening 200 to allow more light to go into the front ornamental area. At least one of the lighting member 50, the projection screen 20 and the pattern screen 21 adopts a rigid or semi-rigid structure and could be engaged with the main body of the cabinet 10. Projection screen 20 could be simply tinted or with other type graphics such as brick cladding for an added decorative element. Projection screen 20 is preferably a translucent screen which keeps the flame image hidden when the light source 52 is not illuminated. Pattern screen 21 can be with portions in different color tones to create a multi-tone flame and opaque areas to block the light where it is not wanted to be visible.

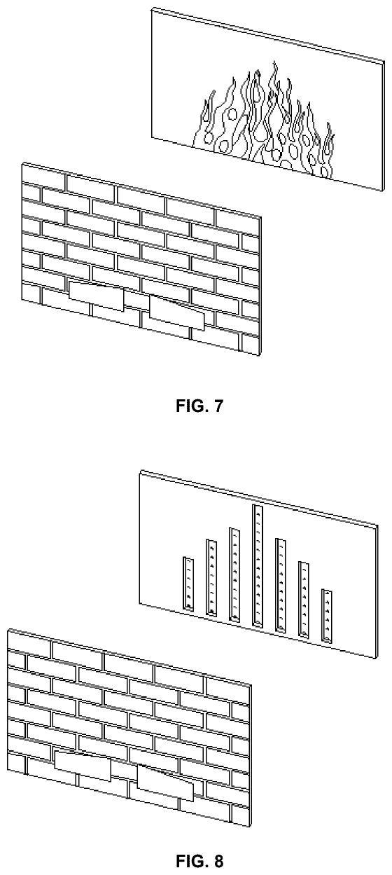

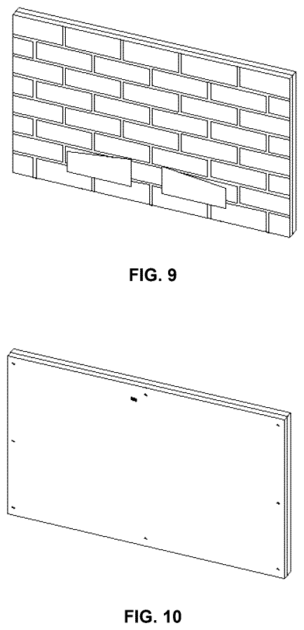

In the embodiment shown in FIG. 7, the lighting member 50 and the pattern screen 21 are combined, and the projection screen 20 is separated so that it can be spaced and create a good effect. In the embodiment shown in FIG. 8, the projection screen 20 and the pattern screen 21 are combined, and the lighting member 50 is separated. In the embodiment shown in FIGS. 9-10, the lighting member 50, the pattern screen 21 and the projection screen 20 are combined to form an integral assembly. It is noted that the combination of the three layers could use an intermediate such as a frame, or a member mounted directly with adhesion or fasteners. With the use of a frame, the thickness of the frame between the layers can be used to control spacing between the layers to create an optimal visual effect. Meanwhile, it is convenient for packaging, maintenance, installation and transportation.

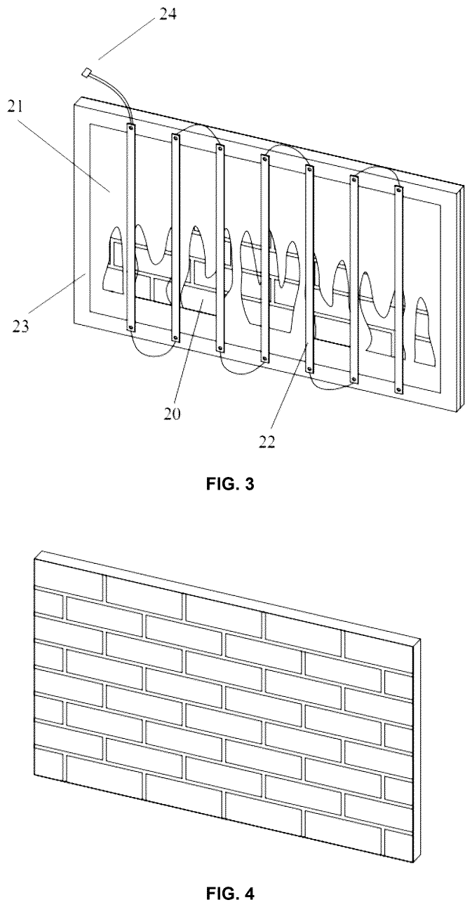

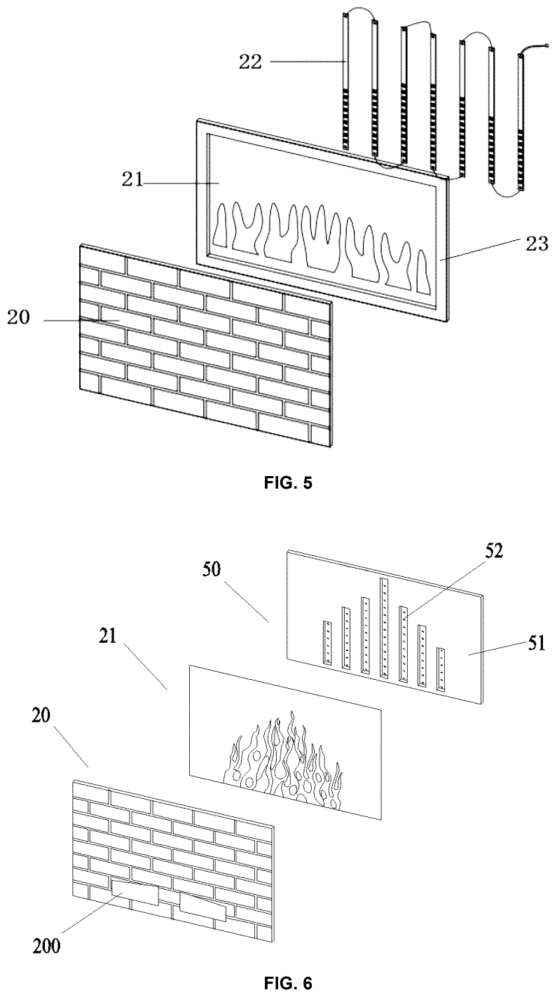

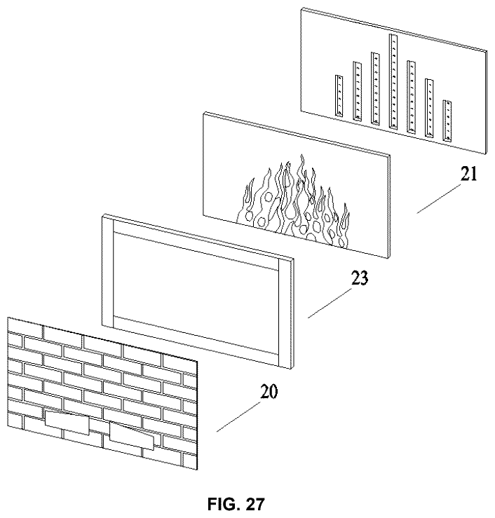

A frame 23 is also shown in the embodiment of FIGS. 26-27 and in FIG. 3. As shown in FIG. 26 and FIG. 27, the frame 23 is disposed between the pattern screen 21 and lighting member 50, or between the pattern screen 21 and projection screen 20. As shown in FIG. 3 and FIG. 5, the light trips 22 could be disposed onto the frame 23 directly. In such an embodiment, the front surface 51 of the light source 52 as described in the above embodiments could be omitted.

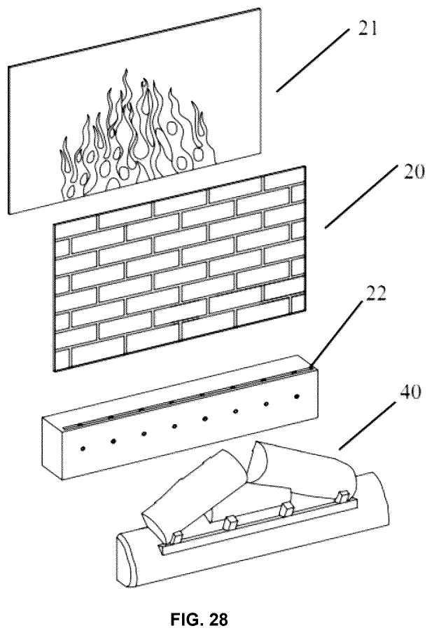

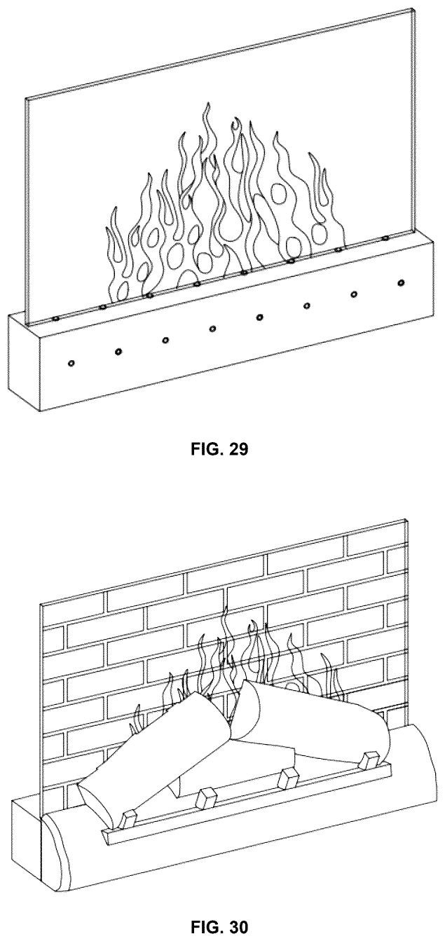

FIGS. 28-30 show another embodiment of the lighting flame simulator according to the present disclosure, in which the LED light strip 22 is pointed upwards and positioned under the pattern screen 21. The LED light strip can be programmed to pulse so that the light flickers upwards and catches the shape of the pattern to project a pulsing flame-like shape. The pattern image may be a reflection in this embodiment. For example, it could be a transparent acrylic panel with an etched shape to catch the light in the shaped areas when it pulses, or a panel with a reflective material shape to reflect the light in that shape area when it pulses. This will further reduce the number of LED needed to illuminate the pattern and size of the lighting module for cost and size efficiencies. In such an embodiment, there can be an additional LED strip positioned and pointed forward to illuminate the decorative module 40 placed in front of the lighting device.

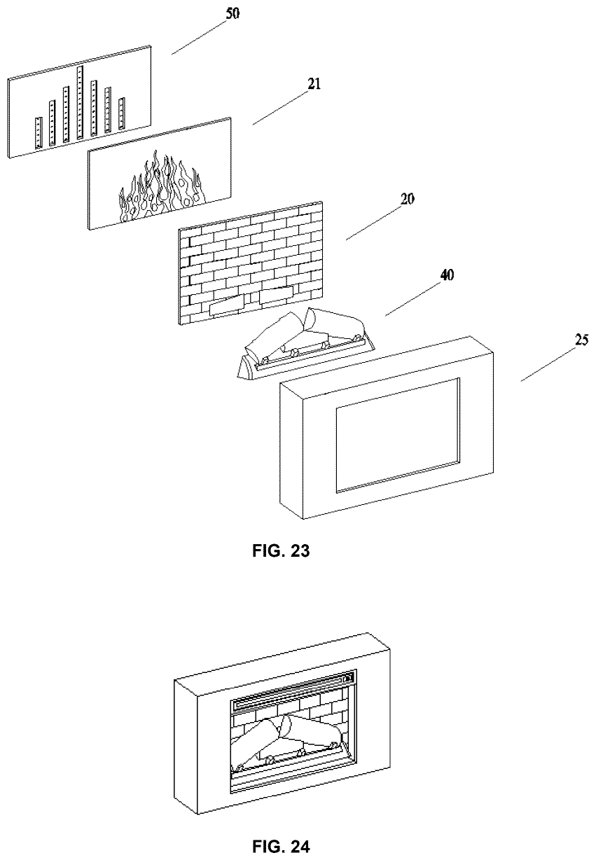

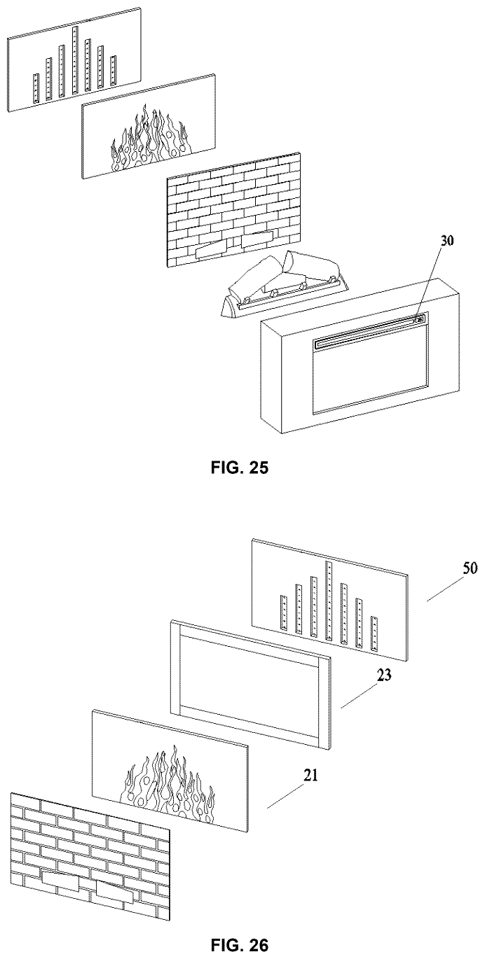

FIGS. 22-23 show another embodiment of the lighting flame simulator according to the present disclosure, wherein the lighting member 50, the pattern screen 21, the projection screen 20 and the decorative module 40 are arranged sequentially, and are all enclosed in a packing member 25 to form an integral assembly, which is easy to be transported and installed, also could protect the components inside the packing member from damage. In another embodiment shown in FIGS. 24-25, the heating module 30 can also be assembled into the packing member 25, so that the convenience of installation and transportation is further improved.

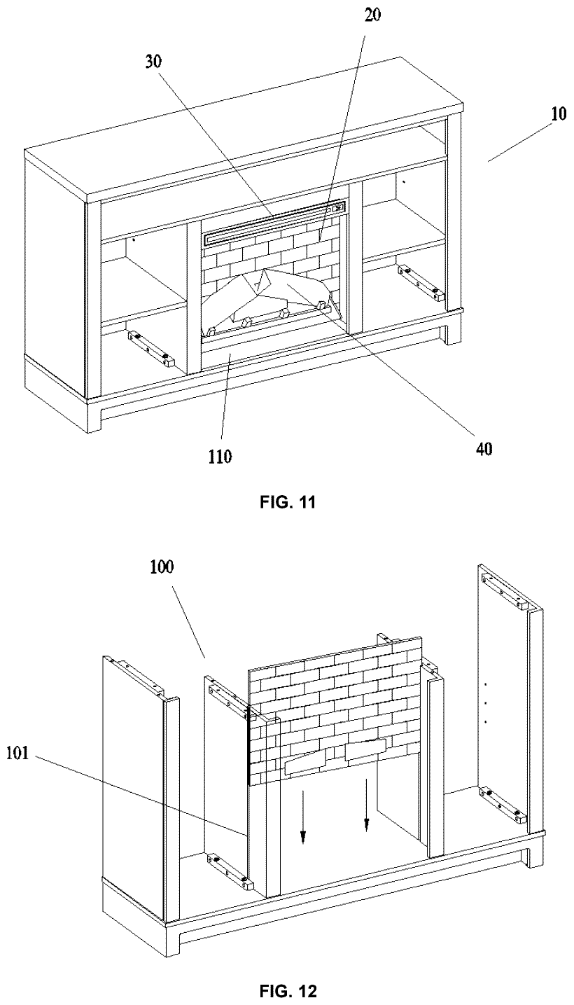

An electric fireplace with a lighting flame simulator of the present disclosure is shown in FIG. 11. As shown, the electric fireplace includes a cabinet 10 with a defined structural opening 110, a lighting flame simulator as described above is disposed in the defined structural opening 110. It is obvious that the cabinet 10 and/or the structural opening 110 can be of any suitable size, shape and design, which depends on the consumer's requirement. Wherein, heating assembly 30 can heat the air and blow it out from the front side. The cabinet 10 may include such as a base portion, two side portions and a top portion. The projection screen 20, the heating module 30 and the decorative module 40 are all arranged within the structural opening 110. Wherein, the heating module 30 can be disposed to the top portion for example by a fastener, the projection screen 20 can be arranged below the heating module 30. Additionally, in certain embodiments, some of the components of the electric fireplace can be positioned in different locations within the electric fireplace depending on the preferences of the consumer and/or the design of the cabinet in which the electric fireplace is installed. In certain embodiments, the cabinet can also be provided to the consumer in the form of a modular cabinet assembly that is configured to be assembled, along with the electric fireplace, by the consumer. In such embodiments, various components of the electric fireplace can be manufactured and installed independently of one another. With such design, all the components of the electric fireplace can be provided in a much smaller overall package, which can provide various cost efficiencies for packaging, shipping and storing, etc. In certain embodiments, the main body of the cabinet could be a steel box for freestanding use, or as a wall-hanger use, or as a fireplace insert.

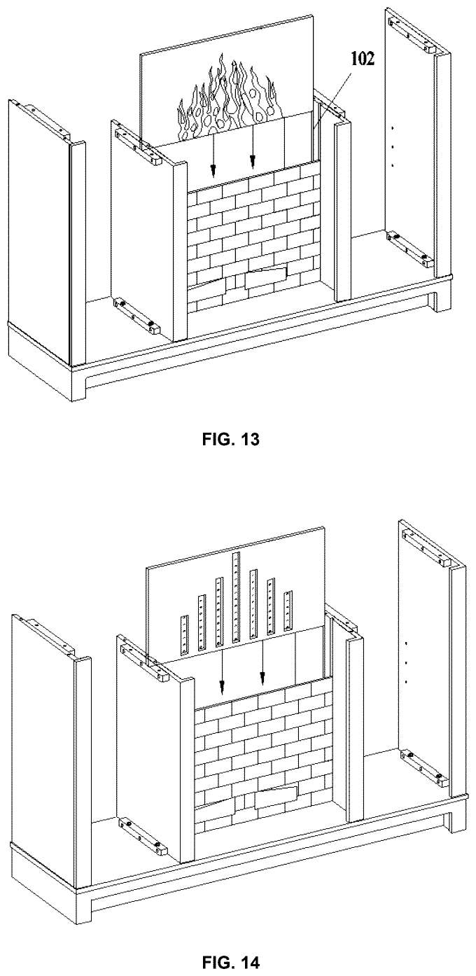

In FIGS. 12-13, a schematic diagram of the installation of the lighting flame simulator of FIG. 7 is shown. Wherein, two pieces of vertically mounted plates 100 are provided on the base portion, at least one of the mounting plates 100 is provided with an engaging portion, which is preferably a groove. During installation, firstly, two mounting plates 100 are vertically installed on the base portion of the main body. After that, the projection screen 20 is inserted into the first groove 101 from above. Then, the combination of the lighting member 50 and pattern screen 21 is inserted into the second groove 102 from above. The first groove 101 and the second groove 102 could be arranged at intervals.

In FIG. 14, a schematic diagram of the installation of the lighting flame simulator of FIG. 8 is shown. Wherein, two pieces of vertically mounted plates 100 are provided inside the main body, the combination of the projection screen 20 and the pattern screen 21 are inserted into the first groove 101 from above, then the lighting member 50 is inserted into the second groove 102 from above. The first groove 101 and the second groove 102 could be arranged at intervals.

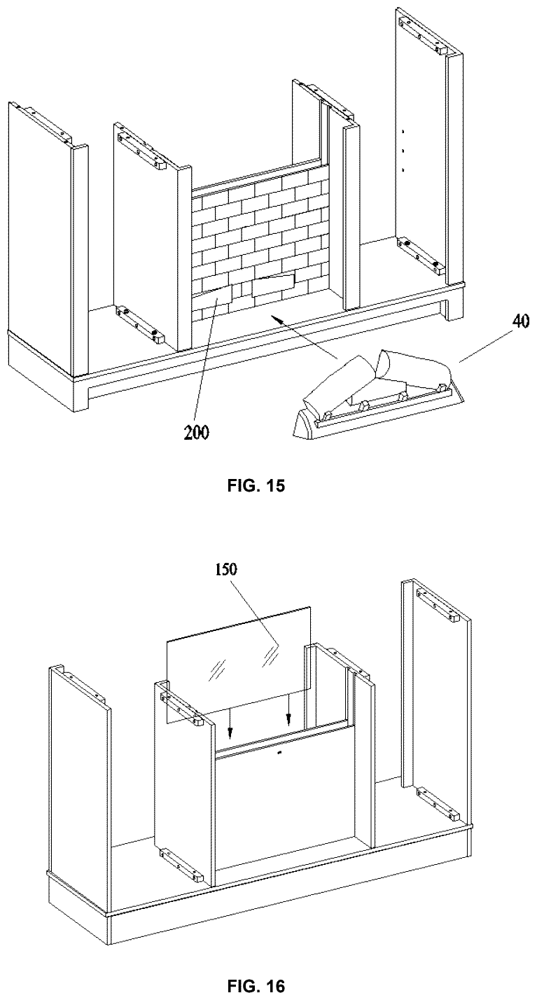

For the embodiment shown in FIGS. 9-10, the combined assembly formed by the lighting member 50, the projection screen 20 and the pattern screen 21 can be directly inserted into the engaging portion. As shown in FIG. 15, a front cover 150 which is preferably made by glass is installed in front of the structural opening, and a cover plate 103 is arranged above the lighting flame simulator. The heating module 30 could be installed on the cover plate 103 through mounting pieces that could match each other.

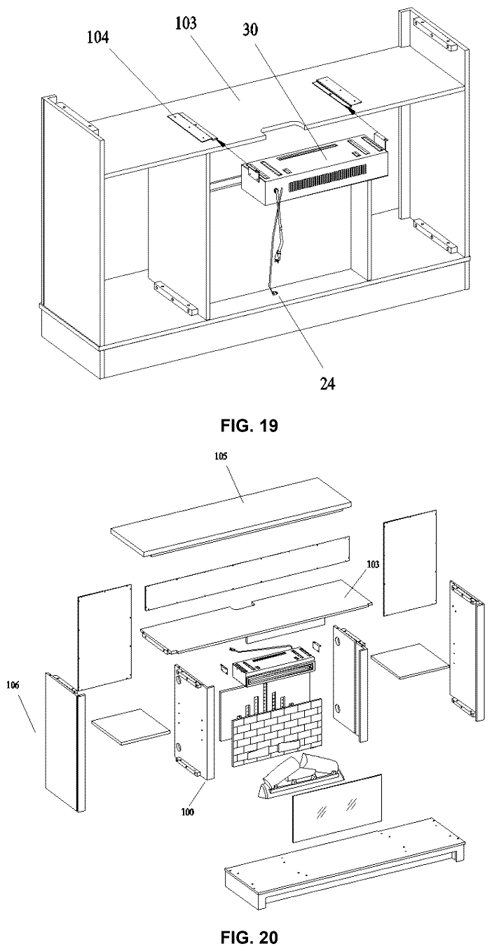

As shown in FIGS. 18-19, two sides of the heating module 30 are respectively provided with a first engaging part 301, which can be bolted to the side wall of the heating module 30. The cover plate 103 is provided with a second engaging part 104, which can be bolted to the cover plate 103. The first engaging part 301 and the second engaging part 104 are pluggable engaged and matched with each other. The heating module 30 could be provided with a low voltage DC connector 24, such as a USB connector which could be connected to the light source 52. Also, the heating module 30 could be provided with an AC connector or other suitable electrical connector, which is selectively electrically connected to the external power source. In some embodiments, electrical connector for certain components of the electric fireplace can be configured to enable the consumer to easily and safely establish such electrical connector so that power is provided to all such electrical components of the electric fireplace.

The low voltage DC connector in the present disclosure could be configured to carry less than for example 50 volts, less than 45 volts, less than 40 volts, less than 35 volts, less than 30 volts, less than 25 volts, less than 20 volts, less than 15 volts, less than 10 volts, or less than 5 volts.

As shown in FIG. 20, an exploded schematic diagram of the fireplace with a lighting flame simulator as described above is shown. In addition to the above-mentioned portions, in the preferred embodiment, the electrical fireplace is also provided with a top plate 105, and the top portion of the electrical fireplace can be formed between the top plate 105 and the cover plate 103.

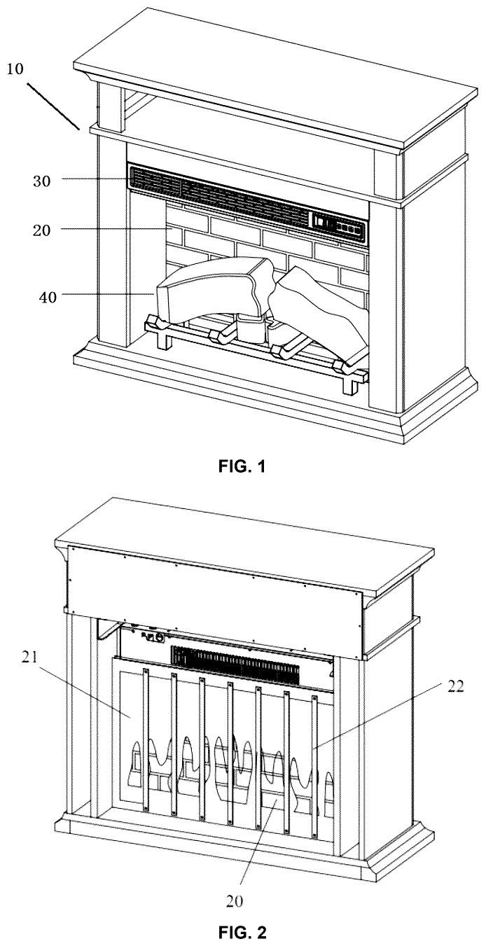

Another example of an electric fireplace with a lighting flame simulator of the present disclosure is shown in FIG. 1. As shown, the electric fireplace also includes a cabinet 10, a projection screen 20 and a heating module 30. A decorative module 40 is provided in front of the projection screen 20, which could be a log. The projection screen 20, the heating module 30 and the decorative module 40 are provided in the cabinet 10. The cabinet 10 comprises a main body, which may include such as a base portion, walls on both sides and a top portion. The rear side of the projection screen 20 can be provided with a pattern screen 21. The projection screen 20 and the pattern screen 21 can be arranged separately, or be engaged to form an integral screen assembly. At least one of the projection screen 20 and the pattern screen 21 adopts a rigid or semi-rigid screen and could be engaged with the main body of the cabinet 10. For example, the projection screen 20 and the pattern screen 21 can be fixed to the main body by fasteners or can be inserted into a slot provided on the main body.

The rear of the pattern screen 21 is provided with a light source, and the light source may be a light strip 22 for example. The color and brightness of the light strip 22 can preferably be controlled through a programmable controller, so as to present different simulation effects, such as fire flames and so on. The light source can comprise multiple lamps dispersedly arranged, which are controlled by a controller to display a lighting effect correspondingly and can change dynamically. Light source can also be fixed to the main body of the cabinet, or to the back panel, or even to the structural wall of the building behind the cabinet. Light source can also be set up separately from the screen assembly, forming a separate lighting module for easy replacement and repair.

As shown in FIGS. 2-5, a pattern screen 21 is provided at the rear of the projection screen 20, at least one light strip 22 is arranged at the rear of the pattern screen 21. As shown, several vertically positioned light strips 22 are positioned behind the pattern screen 21. The light strips 22 can be programmed to move in an upwards or downwards flame-like motion and can be connected with a connector 24. Additionally, a reflective sheet can be provided at the rear of the light strip 22, which could create additional light glow from the back and edges while reducing the amount of light strips needed to create the effect.

In a preferred embodiment, as shown in FIGS. 3-4, the projection screen 20 and the pattern screen 21 could be disposed onto a frame 23, forming a frame module and allowing for the fireplace to be assembled at the factory level for better packaging efficiencies. The frame 23 could also be slotted into the fireplace walls for easy finished assembly at the end user level. In this embodiment, the projection screen 20 and the pattern screen 21 could be flexible and/or foldable screens and form a screen assembly so as to take up less space when packing, shipping and/or storage, and the light strips 22 could be mounted onto the frame 23 of the screen assembly. In another preferred embodiment, the decorative module 40 can be cut in half and pre-mounted to the projection screen 20, to improve assembly as it is a single piece with the decorative module pre-attached.

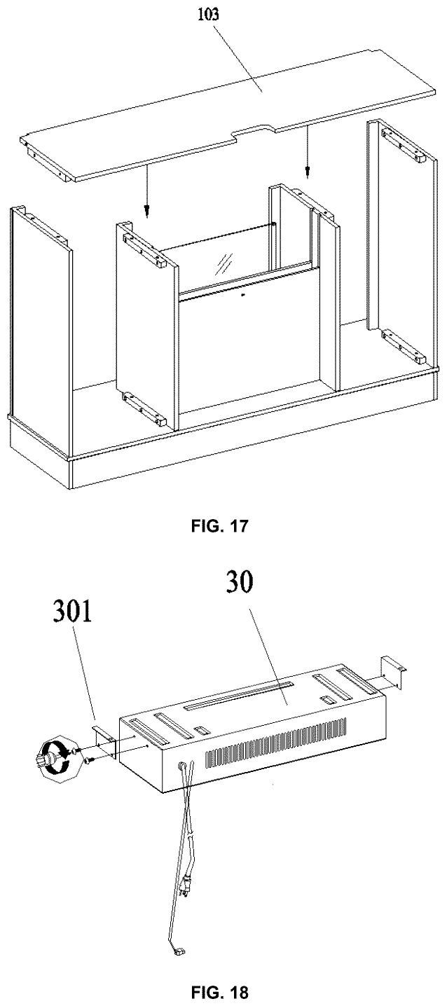

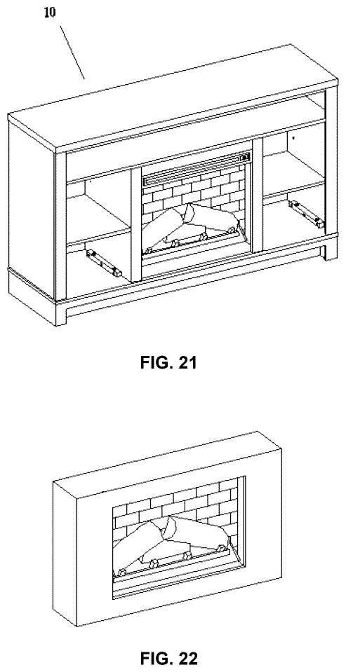

The present disclosure also relates a method for assembling an electric fireplace with a lighting flame simulator, which could be seen from FIGS. 12-21, comprising the steps of:
providing a cabinet assembly in an unassembled configuration, the cabinet assembly including a plurality of unassembled, cabinet structural components;
assembling a part of the cabinet structural components to form a base portion and mounting two pieces of vertically mounted plates on the base portion;
positioning a lighting flame generator to engage with the vertically mounted plates; the lighting flame generator comprising a programmable light source, a pattern screen and a projection screen, the pattern screen providing with a translucent image which is visible when the light source is working, the projection screen providing with translucent and transparent areas or the projection screen being a translucent screen; preferably, further comprising placing a decorative module in front of the projection screen; wherein the decorative module is enclosed with the programmable light source, a pattern screen and a projection screen to form an integral assembly;
assembling a cover plate above the lighting flame generator;
assembling a heating module onto the cover plate; preferably, further comprising electrically connecting the light source to the heating module with a low voltage connector;
assembling other cabinet structural components to form an electric fireplace.

Preferably, when positioning the lighting flame generator, the lighting member and the pattern screen are combined, the projection screen is separated; or the projection screen and the pattern screen are combined, the lighting member is separated; or the lighting member, the pattern screen and the projection screen are combined to form an integral assembly.

The present disclosure can control the brightness and color changes of the light source by setting up programmable light source in the cabinet, so as to form different lighting effects on the screen assembly and meet the decorative requirements of the cabinet. The cabinet of this disclosure does not need to rely on the motor to drive the reflector rotating to realize the change of decorative effect, so as to avoid noise occurred in use and improve the user experience, also save the cost of the motor. Additionally, due to the elimination of the rotary flame generator module, the installation space within the cabinet is saved, and the size can be smaller, thus saving more materials and costs. Such flame generator assembly without motor and rotary reflectors will also reduce the needed depth to create a flame effect and would allow to make a more compacted product such as wall-hanging electric fireplaces.

1. A lighting flame simulator, comprising a light source, a pattern screen and a projection screen,
wherein the light source is a programmable light source, the pattern screen is provided with a translucent image which is visible when the light source is working, or the pattern screen has a transparent area or a cut-out opening to let light through as well as opaque areas to block the light, the projection screen is provided with translucent and transparent areas or is a translucent screen.

2. The lighting flame simulator according to claim 1, wherein the programmable light source is a light strip, which is controlled through a programmable controller, or the programmable light source comprises dispersedly arranged multiple lamps, which are controlled by a programmable controller, or the programmable light source includes a PCB upon which is provided with one or more LED light bulbs.

3. The lighting flame simulator according to claim 1, wherein the programmable light source is arranged on a reflective surface or a reflective membrane to form a lighting member, or the programmable light source is arranged in an enclosure to form a lighting member, or the programmable light source is arranged under the pattern screen.

4. The lighting flame simulator according to claim 1, wherein in front of the projection screen is provided with a decorative module, the projection screen has a transparent area or opening to allow light to go into the decorative module.

5. The lighting flame simulator according to claim 3, wherein at least one of the lighting member, the projection screen and the pattern screen adopts a rigid or semi-rigid structure.

6. The lighting flame simulator according to claim 3, wherein the lighting member and the pattern screen are combined, and the projection screen is separated; or the projection screen and the pattern screen are combined, and the lighting member is separated; or the lighting member, the pattern screen and the projection screen are combined to form an integral assembly.

7. The lighting flame simulator according to claim 6, wherein the combination is achieved by using an intermediate or an adhesion or a fastener.

8. The lighting flame simulator according to claim 7, wherein the intermediate is a frame, at least two of the lighting member, a pattern screen and a projection screen are disposed on the frame.

9. The lighting flame simulator according to claim 7, wherein the intermediate is a frame, at least the programmable light source is disposed on the frame.

10. The lighting flame simulator according to claim 1, further comprising at least one of a heating module and a decorative module, wherein at least one of the heating module and the decorative module are enclosed in a packing member to form an integral assembly with the light source, the pattern screen and the projection screen.

11. An electric fireplace, comprising a lighting flame simulator according to claim 1 and a cabinet, wherein the cabinet defines a structural opening, when in an assembled configuration, the lighting flame simulator is selectively positioned within the structural opening.

12. The electric fireplace according to claim 11, wherein the cabinet is provided in a form of a modular cabinet assembly that is configured to be assembled, along with the lighting flame simulator.

13. The electric fireplace according to claim 12, wherein two pieces of vertically mounted plates are provided in the cabinet, at least one of the mounting plates is provided with an engaging portion for engaging with the lighting flame simulator.

14. The electric fireplace according to claim 12, further comprising a heating module, wherein the heating module is pluggable engaged with a cover plate which is provided above the lighting flame simulator.

15. A combination that is configured for receipt by a consumer, the combination comprising the electric fireplace of claim 11 in an assembled configuration and a package assembly; wherein the electric fireplace is positionable within the package assembly when in an unassembled configuration; and
wherein the package assembly with the electric fireplace in the unassembled configuration positioned therein is selectively receivable by the consumer.

16. A method for assembling an electric fireplace, comprising the steps of:
providing a cabinet assembly in an unassembled configuration, the cabinet assembly including a plurality of unassembled, cabinet structural components;
assembling a part of the cabinet structural components to form a base portion and mounting two pieces of vertically mounted plates on the base portion;
positioning a lighting flame generator to engage with the vertically mounted plates; the lighting flame generator comprising a programmable light source, a pattern screen and a projection screen, the pattern screen providing with a translucent image which is visible when the light source is working, the projection screen providing with translucent and transparent areas or the projection screen being a translucent screen;
assembling a cover plate above the lighting flame generator;
assembling a heating module onto the cover plate;
assembling other cabinet structural components to form an electric fireplace.

17. The method according to claim 16, further comprising placing a decorative module in front of the projection screen.

18. The method according to claim 17, wherein the decorative module is enclosed with the programmable light source, a pattern screen and a projection screen to form an integral assembly.

19. The method according to claim 16, when positioning the lighting flame generator, the lighting member and the pattern screen are combined, the projection screen is separated; or the projection screen and the pattern screen are combined, the lighting member is separated; or the lighting member, the pattern screen and the projection screen are combined to form an integral assembly.

20. The method according to claim 16, further comprising electrically connecting the light source to the heating module with a low voltage connector.
